(19) United States
(12) Patent Application Publication
(10) Pub. No.: US 2025/0343662 A1
(43) Pub. Date: Nov. 6, 2025

(54) METHOD, USER EQUIPMENT, AND ACCESS NETWORK NODE

(71) Applicant: NEC CORPORATION, Tokyo (JP)

(72) Inventor: Tingyu XIN, Staines (GB)

(73) Assignee: NEC Corporation, Minato-ku, Tokyo (JP)

(21) Appl. No.: 18/868,272

(22) PCT Filed: May 16, 2023
(86) PCT No.: PCT/JP2023/018330

§ 371 Date: Nov. 22, 2024

(30) Foreign Application Priority Data
May 30, 2022 (GB) 2207957.8

(51) Int. Cl. H04L 5/00; H04W 56/00

(52) U.S. Cl. CPC H04L 5/0091; H04L 5/0048; H04W 56/001

(57) ABSTRACT

A system is disclosed which uses a first pattern for a Synchronization Signal Block (SSB) having a first periodicity and a second pattern for the SSB having a second periodicity. The SSBs in the first and second periodicities are repeated sequentially with a third periodicity which is based on a combination of the first and second periodicities. A base station transmits pattern information to a user equipment (UE) that identifies at least one specific block of resources in the first periodicity and at least one different block of resources in the second periodicity in which the SSB is present.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to energy saving in the so-called ‘5G’ or ‘New Radio’ systems (also referred to as ‘Next Generation’ systems) and similar systems.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication between the UEs and the base station is controlled using the so-called Radio Resource Control (RRC) protocol. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, NPL 1.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 2 and NPL 3 define the following nodes, amongst others:
gNB: node providing NR user plane and control plane protocol terminations towards the UE, and connected via the NG interface to the 5G core network (5GC).
ng-eNB: node providing Evolved Universal Terrestrial Radio Access (E-UTRA) user plane and control plane protocol terminations towards the UE, and connected via the NG interface to the 5GC.
En-gNB: node providing NR user plane and control plane protocol terminations towards the UE, and acting as Secondary Node in E-UTRA-NR Dual Connectivity (EN-DC).
NG-RAN node: either a gNB or an ng-eNB.

The term base station or RAN node is used herein to refer to any such node.

Energy consumption of base stations and other similar access network nodes represents a major operational expenditure for network operators. There are various tools to save energy at the network side. For example, capacity cells (i.e. cells that are deployed for assisting certain areas in peak times) can be switched off and neighbouring cells are aware of whether the capacity cell is available or not. This function allows, for example in a deployment where capacity boosters can be distinguished from cells providing basic coverage, to optimise energy consumption enabling the possibility for an E-UTRA cell or an E-UTRA—New Radio Dual Connectivity (EN-DC) cell providing additional capacity via single or dual connectivity, to be switched off when its capacity is no longer needed and to be re-activated on a need basis.

In general, the network can decide to switch off an entire cell if UEs can be offloaded to neighbouring cells. However this may not always be feasible, e.g. for coverage cells if no other cell is available (as the network still has to ensure service to UEs). Moreover, in some cases switching off an entire cell would result in neighbouring cells using more power (to enhance their coverage) than it would save for the cell being switched off. It would also cause some overhead signalling related to handover of UEs to a suitable neighbour cell.

There are other methods to save energy at the network (base station). For example, certain functions may be “turned off” independently for relatively short periods of time. For example, Synchronisation signals (Primary Synchronization Signal (PSS) and Secondary Synchronization Signal (SSS)) and the Master Information Block (MIB) may be transmitted with a periodicity of 5 ms, 10 ms, 20 ms, 40 ms, 80 ms, or 160 ms. Hence, it is possible in legacy systems to virtually switch-off a cell for up to 160 ms by limiting the broadcast of signalling channels and configuring data resources around the time when the cell is on and transmitting these channels.

The so-called Synchronization Signal Block (SSB) refers to a block of resources carrying various signals which are packed as a single block that always moves together. The main components of this block are the synchronization signals (including PSS, SSS) and the Physical Broadcast Channel (PBCH) which includes the Demodulation Reference Signal (DMRS) and PBCH data. It will be appreciated that an SSB may carry various other signals as well. The SSB may also be referred to as the ‘SS Block’ or SS/PBCH Block’.

The structure of the typical SS/PBCH block is defined in NPL 4 (for NR). In the time domain, the SS/PBCH block consists of 4 Orthogonal Frequency Division Multiplexing (OFDM) symbols, numbered in increasing order from 0 to 3 within the SS/PBCH block. In the frequency domain, the SS/PBCH block consists of 240 contiguous subcarriers with the subcarriers numbered in increasing order from 0 to 239 within the SS/PBCH block.

Although the term ‘SS Block’ is not used in LTE, LTE also groups the PSS/SSS and PBCH in a single block. There are some high level differences between the LTE SS Block and the SSB used in NR. The time domain transmission pattern of the SS Block in NR is more complicated than in LTE (which has only one pattern for SSB transmission). In LTE, the subframe number and OFDM symbol number within the subframe is always the same, whereas NR can chose from various time domain patterns for the SSB transmission.

In NR, NPL 4 specifies that, for a half frame with SS/PBCH blocks, the first symbol indexes for candidate SS/PBCH blocks are determined based on the subcarrier spacing (SCS), carrier frequencies, whether paired or unpaired spectrum is used, and operation with shared spectrum channel access or not.

Reception of the SS/PBCH is in a half frame within each periodicity. A UE can be provided a periodicity (per serving cell) via the ssb-periodicity ServingCell information element. The periodicity refers to the periodicity of the half frames for the reception of the SS/PBCH blocks for the given serving cell. The possible values for ssb-periodicity ServingCell are 5 ms, 10 ms, 20 ms, 40 ms, 80 ms, and 160 ms (if the parameter is not provided, the UE assumes a periodicity of 5 ms for the half frames).

It is not required to transmit all SSBs in the configured periodicity. The so-called SSB transmission pattern defines which SSB is transmitted using an associated bitmap. The network can selectively transmit only a few SSB and inform the UEs about which SSBs are transmitted and which SSBs are not transmitted. This transmission pattern is informed via a RRC information element called ssb-PositionInBurst.

### CITATION LIST

### Non Patent Literature

NPL 1: ‘NGMN 5G White Paper’ V1.0, Next Generation Mobile Networks (NGMN) Alliance, <https://www.ngmn.org/5g-white-paper.html>
NPL 2: 3GPP Technical Specification (TS) 38.300 V16.7.0
NPL 3: 3GPP TS 37.340 V16.7.0
NPL 4: 3GPP TS 38.211 V16.9.0
NPL 5: 3GPP TS 38.213 V16.13.0
NPL 6: 3GPP TS 22.368 V13.1.0

### SUMMARY OF INVENTION

### Technical Problem

However, the current patterns and periodicities for the SSB block (which SSB blocks are on/off) are somewhat limited because the selection of an appropriate combination of SSB pattern and periodicity requires sacrificing either some of the energy saving potential or the coverage of the cell.

Accordingly, the present disclosure seeks to provide methods and associated apparatus that address or at least alleviate (at least some of) the above-described issues.

### Solution to Problem

In one aspect, the disclosure provides a method performed by a user equipment (UE), the method comprising: receiving pattern information identifying two or more patterns for a plurality of blocks of resources, each pattern having a respective periodicity, and identifying a further periodicity which is based on a combination of the respective periodicities for the two or more patterns; wherein the two or more patterns are repeated sequentially with the further periodicity.

In one aspect, the disclosure provides a method performed by a user equipment (UE), the method comprising: transmitting, to a network node, a request to receive at least one of a synchronization signal and broadcast channel block and minimum system information for accessing a cell; and monitoring for the at least one of the synchronization signal and broadcast channel block and minimum system information based on the request.

In one aspect, the disclosure provides a method performed by an access network node, the method comprising: transmitting, to at least one user equipment (UE), pattern information identifying two or more patterns for a plurality of blocks of resources, each pattern having a respective periodicity, and identifying a further periodicity which is based on a combination of the respective periodicities for the two or more patterns: wherein the two or more patterns are repeated sequentially with the further periodicity.

In one aspect, the disclosure provides a method performed by an access network node, the method comprising: transmitting a synchronization signal and broadcast channel over at least one block of resources based on at least one of a network load and a request from at least one user equipment (UE).

In one aspect, the disclosure provides a user equipment (UE) comprising: means (for example a memory, a controller, and a transceiver) for receiving pattern information identifying two or more patterns for a plurality of blocks of resources, each pattern having a respective periodicity, and identifying a further periodicity which is based on a combination of the respective periodicities for the two or more patterns; wherein the two or more patterns are repeated sequentially with the further periodicity.

In one aspect, the disclosure provides a user equipment (UE) comprising: means (for example a memory, a controller, and a transceiver) for transmitting, to a network node, a request to receive at least one of a synchronization signal and broadcast channel block and minimum system information for accessing a cell; and means for monitoring for the at least one of the synchronization signal and broadcast channel block and minimum system information based on the request.

In one aspect, the disclosure provides an access network node comprising: means (for example a memory, a controller, and a transceiver) for transmitting, to at least one user equipment (UE), pattern information identifying two or more patterns for a plurality of blocks of resources, each pattern having a respective periodicity, and identifying a further periodicity which is based on a combination of the respective periodicities for the two or more patterns; wherein the two or more patterns are repeated sequentially with the further periodicity.

In one aspect, the disclosure provides an access network node comprising: means (for example a memory, a controller, and a transceiver) for transmitting a synchronization signal and broadcast channel over at least one block of resources based on at least one of a network load and a request from at least one user equipment (UE).

Aspects of the disclosure extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Although for efficiency of understanding for those of skill in the art, the disclosure will be described in detail in the context of a 3GPP system (5G networks), the principles of the disclosure can be applied to other systems as well.

The present disclosure is defined by the claims appended hereto. Aspects of the disclosure are as set out in the independent claims. Some optional features are set out in the dependent claims.

However, each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the disclosure will now be described, by way of example, with reference to the accompanying drawings in which:

FIG. 1 illustrates schematically a mobile (cellular or wireless) telecommunication system to which example embodiments of the disclosure may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1;

FIG. 5 illustrates schematically an exemplary way in which network energy saving may be realised in the system shown in FIG. 1;

FIG. 6 illustrates schematically an exemplary way in which network energy saving may be realised in the system shown in FIG. 1;

FIG. 7 illustrates schematically an exemplary way in which network energy saving may be realised in the system shown in FIG. 1;

FIG. 8 illustrates schematically an exemplary way in which network energy saving may be realised in the system shown in FIG. 1;

FIG. 9 illustrates schematically an exemplary way in which network energy saving may be realised in the system shown in FIG. 1;

FIG. 10 illustrates schematically an exemplary way in which network energy saving may be realised in the system shown in FIG. 1;

FIG. 11 illustrates schematically an exemplary way in which network energy saving may be realised in the system shown in FIG. 1;

FIG. 12 illustrates schematically an exemplary way in which network energy saving may be realised in the system shown in FIG. 1; and

FIG. 13 illustrates schematically an exemplary way in which network energy saving may be realised in the system shown in FIG. 1.

### DESCRIPTION OF EMBODIMENTS

### Overview

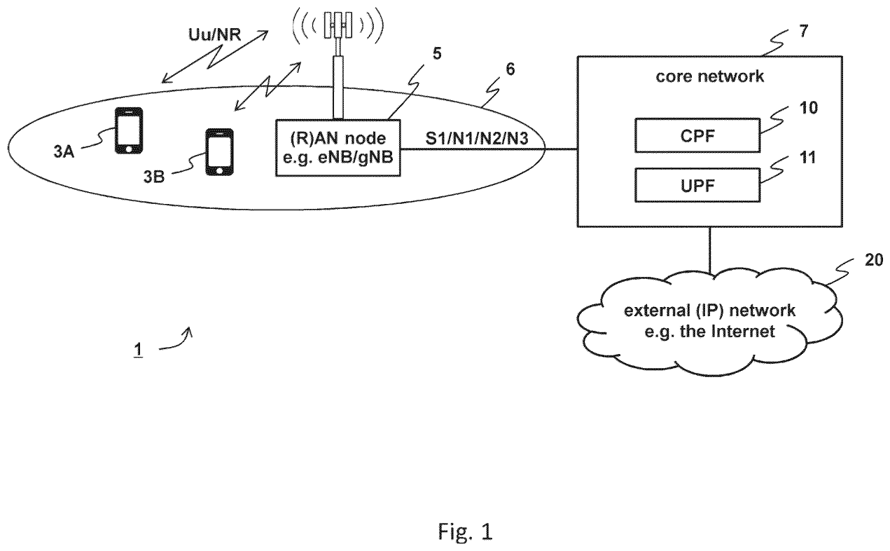

FIG. 1 illustrates schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst two mobile devices 3A and 3B and one base station 5 are shown in FIG. 1 for illustration purposes, the system, when implemented, will typically include other base stations/(R)AN nodes and mobile devices (UEs).

Each base station 5 controls one or more associated cell 6 (either directly or via other nodes such as home base stations, relays, remote radio heads, distributed units, and/or the like). A base station 5 that supports Next Generation/5G protocols may be referred to as a ‘gNBs’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 10 and one or more user plane functions (UPFs) 11. For example, the so-called Access and Mobility Management Function (AMF) in 5G, or the Mobility Management Entity (MME) in 4G, is responsible for handling connection and mobility management tasks for the mobile devices 3, and the Session Management Function (SMF) is responsible for handling communication sessions for the mobile devices 3 such as session establishment, modification and release. The core network 7 is coupled (via the UPF 11) to a data network 20, such as the Internet or a similar Internet Protocol (IP) based network.

In this system 1, energy saving may be realised using one or more of the following techniques.

The base station may be configured to transmit, to the UEs 3 in its cell, pattern information identifying two or more patterns for a plurality of blocks of resources (such as SSB blocks), each pattern having a respective periodicity, and identifying a further periodicity which is based on a combination of the respective periodicities for the two or more patterns. The two or more patterns are repeated sequentially with the further periodicity.

Effectively, respective patterns may be used for at least i) a first signalling group comprising a first plurality of blocks of resources for the synchronization and broadcast signalling (SSB and/or the like), and ii) a second signalling group comprising a second plurality of blocks of resources for synchronization and broadcast signalling. The first and second signalling groups are repeated sequentially with a periodicity which is based on a combination of the periodicities of the first and second signalling groups. The base station 5 transmits configuration information (pattern information) to the UE 3 that identifies a first pattern associated with the first signalling group (at least one specific block of resources in the first signalling group) and a second pattern associated with the second signalling group (at least one specific block of resources in the second signalling group) in which the synchronization and broadcast signalling are present.

In order to achieve further energy savings, it is proposed to turn off SSB transmission (at least when energy saving operation is enabled) and to provide SSB and associated signalling such as minimum system information on demand. Alternatively, the SSB transmission may be kept on but it may employ a pattern in which SS/PBCH blocks are transmitted with relatively large gaps between them, to benefit from some energy savings. When a UE 3 needs to receive the SSB in the cell, e.g. to receive minimum system information carried in the MIB and SIB1, the UE 3 transmits an appropriate request to the base station 5 operating the cell (or another base station serving the UE 3) to start transmitting the SS/PBCH block or to change the periodicity or pattern associated with the SS/PBCH block. It will be appreciated that the SS/PBCH block transmission state (on/off) and the associated parameters (SSB pattern/periodicity) may be controlled based on cell load, in addition or instead of UE requests.

In order to ensure backwards compatibility, legacy UEs 3 that do not support the enhanced patterns or energy saving techniques may be barred from accessing the cells (at least while the incompatible patterns and/or network energy saving functionality are used).

### User Equipment (UE)

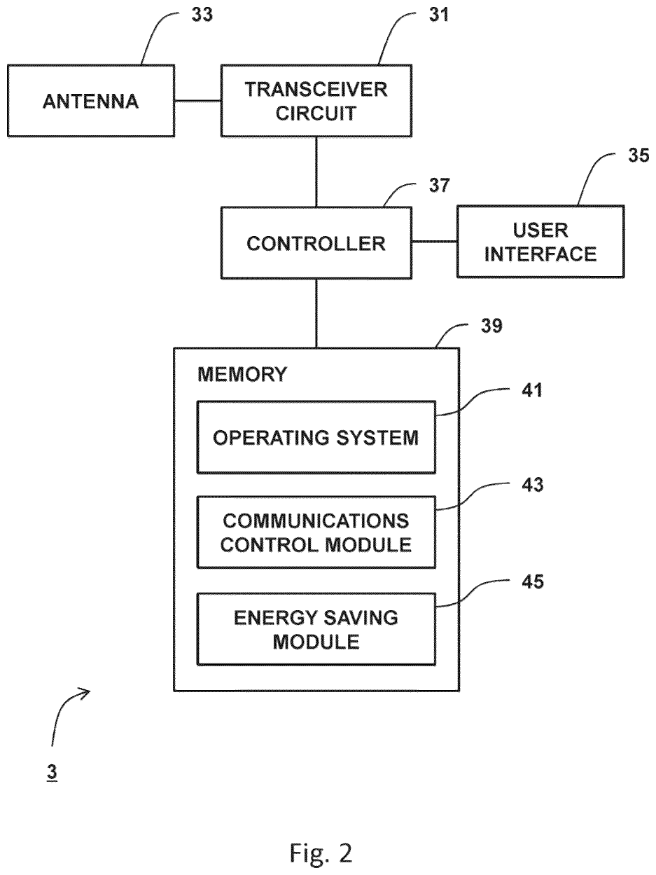

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and an energy saving module 45.

The communications control module 43 is responsible for handling (generating/sending/receiving) signalling messages and uplink/downlink data packets between the UE 3 and other nodes, including (R)AN nodes 5 and core network nodes. The signalling may comprise control signalling (e.g. via system information or RRC) related to the energy saving operation. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an SDAP sub-module, an IP sub-module, an RRC sub-module, etc.

The energy saving module 45 is responsible for operations relating to energy saving (by the UE 3 itself and/or by network nodes such as the access network node/base station 5). Energy saving is typically achieved by turning off certain components (e.g. the transceiver circuit 31) for certain periods.

### Access Network Node (Base Station)

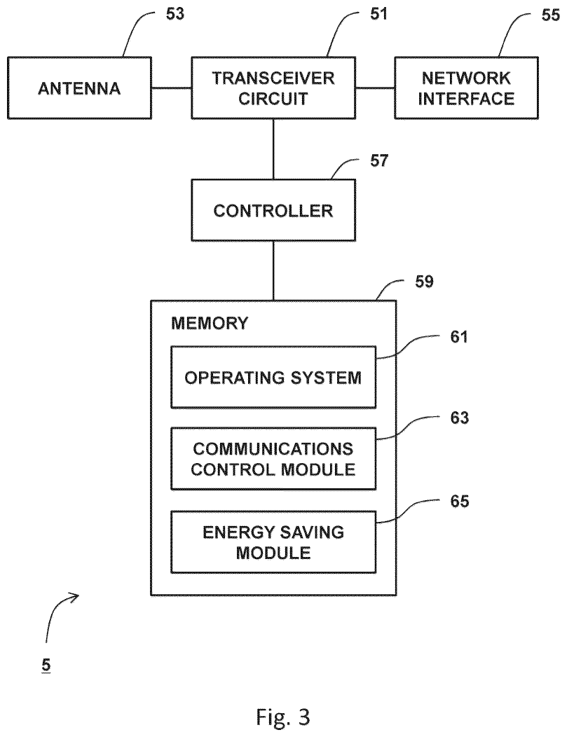

FIG. 3 is a block diagram illustrating the main components of the base station 5 (or a similar access network node) shown in FIG. 1. As shown, the base station 5 includes a transceiver circuit 51 which is operable to transmit signals to and to receive signals from connected UE(s) 3 via one or more antenna 53 and to transmit signals to and to receive signals from other network nodes (either directly or indirectly) via a network interface 55. The network interface 55 typically includes an appropriate base station-base station interface (such as X2/Xn) and an appropriate base station-core network interface (such as S1/N1/N2/N3). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and an energy saving module 65.

The communications control module 63 is responsible for handling (generating/sending/receiving) signalling between the base station 5 and other nodes, such as the UE 3 and the core network nodes. The signalling may comprise control signalling (e.g. via system information or RRC) related to the energy saving operation. It will be appreciated that the communications control module 63 may include a number of sub-modules (‘layers’ or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The energy saving module 65 is responsible for operations relating to energy saving (by the UE 3, by the access network node and/or by base station 5 itself). Energy saving is typically achieved by turning off certain components (e.g. the transceiver circuit 51) for certain periods.

### Core Network Function

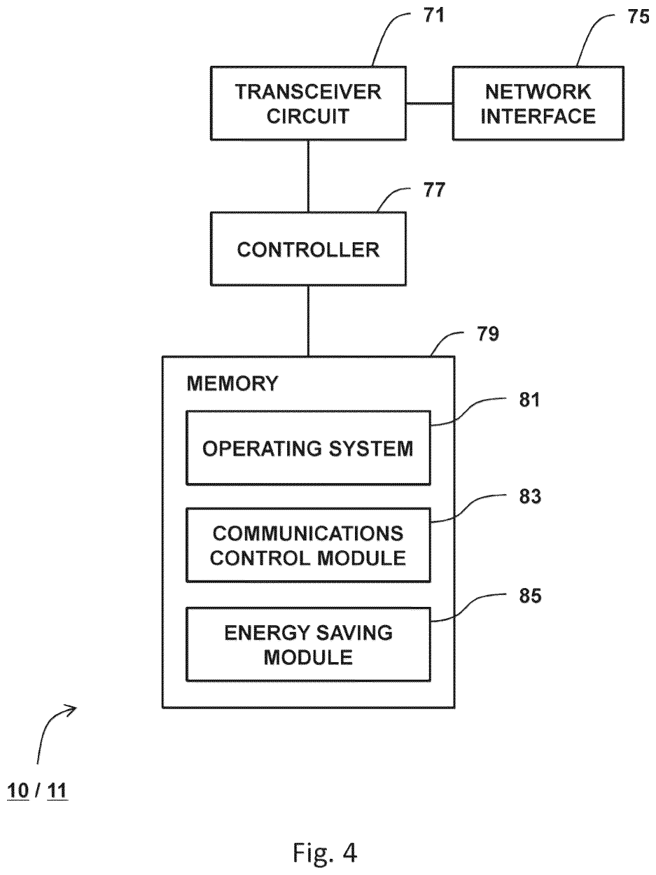

FIG. 4 is a block diagram illustrating the main components of a generic core network function, such as the CPF 10 or the UPF 11 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an energy saving module 85 (which may be optional).

The communications control module 83 is responsible for handling (generating/sending/receiving) signalling between the core network function and other nodes, such as the UE 3, the base station 5, and other core network nodes. The signalling may include for example a UE context/UE capability indication of a UE 3 related to energy saving.

If present, the energy saving module 85 is responsible for operations relating to energy saving (e.g. by the UE 3 and/or by the access network node/base station 5). For example, the energy saving module 85 may provide information relating to the UE's energy saving capability to the base station 5.

### Detailed Description

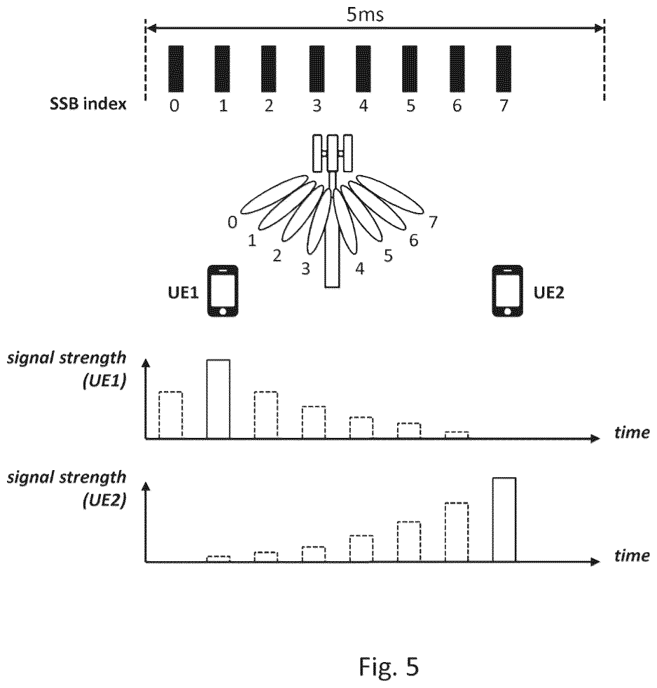

The following is a description of how network energy savings may be realised in the system 1 shown in FIG. 1, with reference to FIGS. 5 to 13. Although in the following detailed description the exemplary use case relates to energy saving at the base station, the techniques may be used for other purposes as well, if appropriate. Moreover, whilst the description refers to SS/PBCH block, it will be appreciated that the following techniques may be applied to any other blocks or sets of resources defined in the frequency and/or time domain.

### Beam Sweeping

FIG. 5 illustrates schematically an exemplary way in which the so-called beam sweeping functionality may be applied to the SSB in the system shown in FIG. 1. Effectively, beam sweeping is implemented by changing the beam direction for each SSB transmission. This allows providing SSB coverage in the whole cell.

For SS/PBCH transmission, each SS/PBCH block index is mapped to a corresponding beam. However, the network may not transmit all the SS/PBCH blocks in the cell due to the applicable SSB pattern. Whilst some patterns are beneficial for energy saving purposes, they may result in poor coverage (or lack of coverage) in some parts of the cell.

Depending on network configuration, the transmitted beams are indicated to the UE 3 via the ssb-PositionInBurst information element in SIB1 (for standalone case) or via dedicated RRC signalling (for the non-standalone case) with an associated bitmap. For example, the following information elements may be used:

| | |
|---|---|
| ssb-PositionsInBurst | SEQUENCE ( |
| inOneGroup | BIT STRING (SIZE (8)), |
| group presence | BIT STRING (SIZE (8)) OPTIONAL-- Cond FR2-Only |

If the maximum number of SS/PBCH blocks per half frame equals to 8, all 8 bits in inOneGroup are used. If it equals to 4, only the 4 leftmost bits are valid. When using 8 bits, the value {10101010} means that SSBs #0, #2, #4, and #6 are transmitted, and SSBs #1, #3, #5, and #7 are not transmitted.

The number of beams being transmitted is determined by how many SSBs are being transmitted within a SSB burst set (a set of SSBs being transmitted in a 5 ms window of SSB transmission). The parameter defining the maximum number of SSBs within a SSB set is called Lmax. In sub 6 Ghz, Lmax is 4 or 8 and in mmWave Lmax is 64. In other words, in sub 6 Ghz carriers, a maximum of 4 or 8 different beams may be used and they sweep in one dimension (horizontal only or vertical only). In mmWave a maximum of 64 different beams may be used and they can sweep in two dimensions (horizontal and vertical directions).

As can be seen in FIG. 5, each UE will detect the beam with the best signal conditions for that UE (from among the beams that are transmitted). In this example, the best beam for ‘UE1’ is the beam associated with SSB index #1, and the best beam for ‘UE2’ is the beam associated with SSB index #7.

### Solution 1—SS/PBCH Patterns for Energy Saving

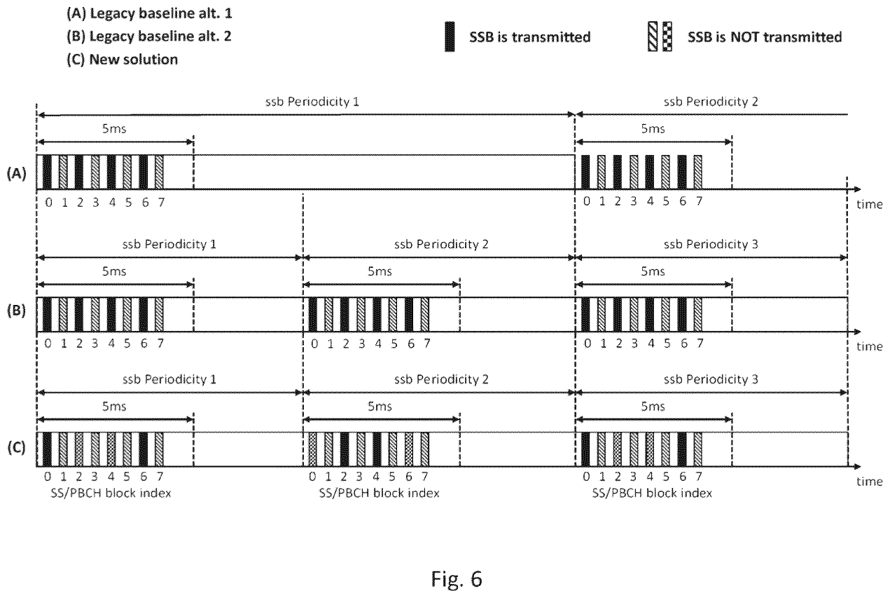

FIG. 6 illustrates schematically the effect of the SSB periodicity on energy saving and network coverage. In this example, case (A) uses a relatively long periodicity and case (B) uses a relatively short periodicity based on the approach defined in NPL 5. In FIG. 6, case (A) is referred to as ‘Legacy baseline alternative 1’ and case (B) is referred to as ‘Legacy baseline alternative 2’.

In such legacy techniques, the network can transmit some of the SS/PBCH in the predefined pattern within each SSB periodicity to achieve energy saving. Energy savings may be further increased by increasing the periodicity. However, the transmitted SS/PBCH patterns in each SSB periodicity are the same, as shown in both cases (A) and (B). Accordingly, whilst case (A) achieves a relatively higher amount of energy saving, the available coverage is the same for both cases (A) and (B). In legacy techniques, coverage may only be improved by reconfiguring the cell to transmit using a pattern in which more SSBs are turned on, which reduces the overall energy saving of the base station, as more SSBs are transmitted within a given periodicity and (the transceiver of) the base station can be turned off for shorter periods of time between consecutive SSB transmissions. However, such reconfiguring cannot be achieved in a dynamic manner.

Case (C) of FIG. 6 illustrates the general concept for a novel approach which reduces the density of the transmitted SS/PBCH without compromising on the coverage or discovery of the cell. As can be seen, in different SSB periodicities, different SSBs are transmitted which results in a more flexible SS/PBCH pattern compared to the legacy techniques. However, over time, case (C) transmits the same SSBs at least once as transmitted in cases (A) and (B).

In the example shown in FIG. 6, SSBs with index 0, 2, 4, 6 are transmitted. In cases (A) and (B), SSBs with index 0, 2, 4, 6 are transmitted in every SSB periodicity. In case (C), in a first periodicity (denoted ‘SSB periodicity 1’), SSBs with index 0, 6 are transmitted, and in a second periodicity (denoted ‘SSB periodicity 2’), SSBs with index 2, 4 are transmitted. The pattern is repeated sequentially, i.e. in the third periodicity (‘SSB periodicity 3’), SSBs with index 0, 6 are transmitted again, and so on. Whilst in the example shown in FIG. 6 two periodicities are combined, it will be appreciated that three or more periodicities may be combined, if appropriate. It will also be appreciated that case (C) may be configured to transmit more SSBs (at least once) than in cases (A) and (B), e.g. by defining further patterns for one or more subsequent periodicity.

Effectively, case (C) uses respective patterns for at least i) a first signalling group comprising a first plurality of blocks of resources for the synchronization and broadcast signalling, the first signalling group having a first periodicity, and ii) a second signalling group comprising a second plurality of blocks of resources for synchronization and broadcast signalling, the second signalling group having a second periodicity. The first and second signalling groups are repeated sequentially with a third periodicity which is based on a combination of the first and second periodicities. The base station 5 transmits configuration information (pattern information) that identifies at least one specific block of resources in the first signalling group and at least one different block of resources in the second signalling group in which the synchronization and broadcast signalling are present.

Beneficially, compared to legacy case (B), the new solution saves up to 50% energy, and compared to legacy case (A), the new solution provides better coverage.

This approach may be realised by providing a new parameter (a new SSB periodicity or SSB pattern parameter) which identifies the applicable pattern for more than one SSB periodicity. This solution may be appliable on top of the legacy SS/PBCH patterns. In other words, the new parameter may be provided in addition to a legacy SSB periodicity or SSB pattern configuration.

For network energy saving purposes, the SS/PBCH pattern in a single ‘legacy’ SSB periodicity may be separated into different ‘legacy’ SSB periodicities within a new SSB periodicity (for example, in FIG. 6, each new SSB periodicity is a combination of two legacy SSB periodicities). The total number of transmitted SSBs (within a new SSB periodicity) may still be determined based on the legacy principles (e.g. SCS, carrier frequency, etc.). The duration of the new/combined SSB periodicity may be configured in units of milliseconds or number of legacy SSB periodicities forming the new/combined SSB periodicity.

Since the UEs 3 need to know which SS/PBCH blocks are transmitted in the cell (e.g. for UE power saving and measurement purposes), the base station 5 is configured to signal the applicable configuration (periodicities/patterns). For example, the new/combined SSB periodicity may be signalled to the UEs 3 using a suitable information element in System Information Block (SIB) Type 1 (SIB1), or any other SIB (including a SIB for network energy saving purposes). The new/combined SSB periodicity may also be signalled to individual UEs 3 using dedicated RRC signalling.

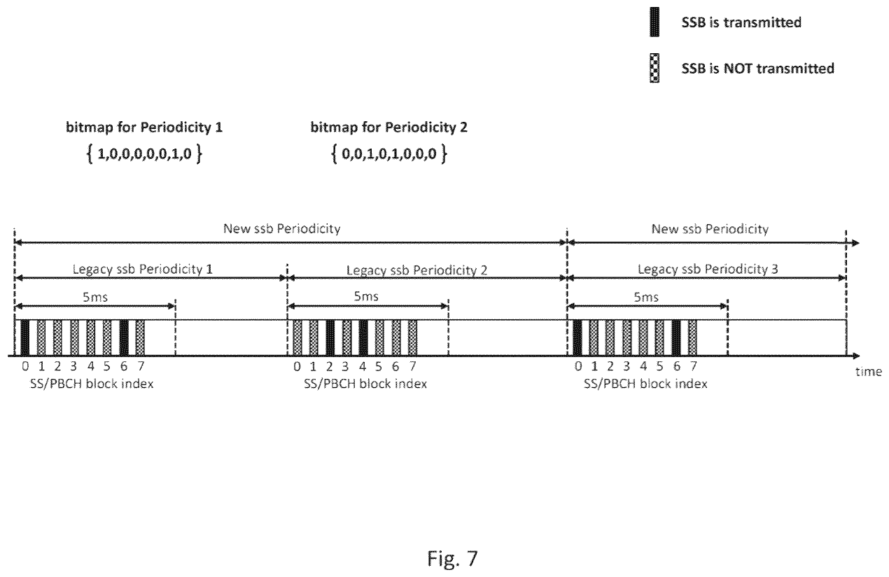

FIGS. 7 to 11 illustrate schematically some of the ways in which the new/combined SSB periodicity may be configured in the cell of the base station 5 and indicated to the UEs 3.

In the example shown in FIG. 7, respective information elements/bitmaps are used to indicate the transmitted SS/PBCH block in each SSB periodicity within the combined SSB periodicity. Effectively, in this case, the combined SSB periodicity includes two parts, each part having its own bitmap to indicate which SSBs are transmitted in that part of the combined SSB periodicity. For the first part, a first information element may indicate a first pattern (using bitmap {1,0,0,0,0,0,1,0} in this example), and for the second part, a second information element may indicate a second pattern (using bitmap {0,0,1,0,1,0,0,0} in this example). In this case, both patterns are associated with the same SSB periodicity and they are applied sequentially. In each bitmap, the first bit indicates whether the first SS/PBCH block is transmitted in that periodicity, the second bit indicates whether the second SS/PBCH block is transmitted in that periodicity, and so on. In this system, the value ‘1’ indicates that the corresponding SS/PBCH block is transmitted and the value ‘0’ indicates that the corresponding SS/PBCH block is not transmitted.

Beneficially, this approach makes it possible to realise the new combined or extended SSB periodicity using the existing information elements and the current bitmap approach. However, this solution requires relatively more bits of signalling, especially in the case when the SSB periodicity combines several legacy SSB periodicities.

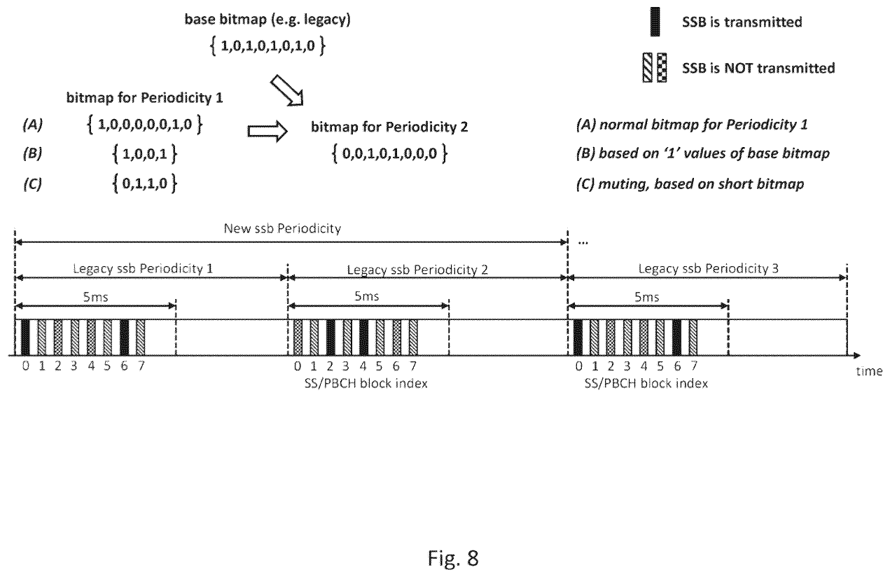

The example shown in FIG. 8 is similar to that of FIG. 7. However, in this example, a first information element (bitmap) indicates the overall SS/PBCH blocks transmitted within the combined SSB periodicity, and a second information element (bitmap) indicates the specific SS/PBCH blocks transmitted in one part of the periodicity (e.g. the first part). The UEs 3 can derive the specific SS/PBCH blocks transmitted in the other part(s) of the periodicity based on the two bitmaps (e.g. any SS/PBCH block not transmitted in the first part is transmitted in the second part).

Thus, in this case, the first information element indicates a base pattern (using bitmap {1,0,1,0,1,0,1,0} in this example), and the second information element indicates the pattern applicable to the first part (using bitmap {1,0,0,0,0,0,1,0} in this example). The UEs 3 are configured to derive the pattern applicable to the second part (i.e. {0,0,1,0,1,0,0,0} in this example) without additional signalling. The patterns are applied sequentially.

It will be appreciated that the base pattern may be provided using the existing information elements and the current bitmap approach. In other words, the legacy bitmap in the ssb-PositionsInBurst information element may still be configured by the network and applied by the UE 3, as the base pattern. A new information element/bitmap may be defined for indicating the SS/PBCH block(s) transmitted in one part of the periodicity (e.g. part ‘L-1’ where ‘L’ is the number of parts or legacy SSB periodicities in the combined/extended SSV periodicity). The UE 3 determines the SS/PBCH block(s) transmitted in the other part(s) of the combined/extended periodicity based on the base bitmap in the ssb-PositionsInBurst information element and the new information element/bitmap. In other words, since each SS/PBCH block included in the base pattern is transmitted at least once, any SS/PBCH block that does not form part of the pattern indicated via the new information element/bitmap forms part of the remaining part(s) of the combined/extended periodicity.

It will be appreciated that there are various ways in which the network (base station 5) may indicate the pattern applicable to a specific part of the periodicity (e.g. the first part). The above example corresponds to option (A) shown in FIG. 8. In this option, the pattern applicable to the first part of the periodicity is indicated using a full bitmap {1,0,0,0,0,0,1,0} having one bit for each potential SS/PBCH block transmission (regardless of the base pattern).

Another example is illustrated in option (B) of FIG. 8. In this option, the pattern applicable to the first part of the periodicity is indicated using a shortened bitmap having one bit for each SS/PBCH block transmission that is enabled by the base pattern. In other words, the base station 5 does not need to signal any information for those SS/PBCH blocks that are indicated in the base pattern as not being transmitted in that periodicity (the corresponding bitmap value is set to ‘0’ in the base bitmap). Thus, the size of the second bitmap depends on how many SS/PBCH blocks are indicated in the base pattern as being transmitted (over the entire combined periodicity).

The first bit of the second bitmap indicates whether the first enabled SS/PBCH block is transmitted in that periodicity, the second bit indicates whether the second enabled SS/PBCH block is transmitted in that periodicity, and so on. In this system, the value ‘1’ indicates that the corresponding SS/PBCH block is transmitted and the value ‘0’ indicates that the corresponding SS/PBCH block is not transmitted (or muted) in the periodicity to which the second bitmap is applicable. Similarly to option (A), the UE 3 determines the SS/PBCH block(s) transmitted in the other part(s) of the combined/extended periodicity based on the base bitmap and the second, short bitmap. Since each SS/PBCH block included in the base pattern is transmitted at least once, any SS/PBCH block that does not form part of the pattern indicated via second bitmap forms part of the remaining part(s) of the combined/extended periodicity.

In the present example, assuming that the base pattern is configured using the bitmap {1,0,1,0,1,0,1,0} (which may be transmitted via the legacy ssb-PositionsInBurst information element), four SS/PBCH blocks with indexes 0, 2, 4, 6 are transmitted in the combined/extended periodicity. Thus, in this case, the four bits of the second bitmap correspond to {SS/PBCH #0, SS/PBCH #2, SS SS/PBCH #4, SS/PBCH #6}, respectively. In the first period (denoted ‘Legacy ssb Periodicity 1’ in FIG. 8), SS/PBCH blocks #0, 6 are transmitted, which is indicated by setting the second bitmap to {1,0,0,1}. In the second period (denoted ‘Legacy ssb Periodicity 2’), SS/PBCH blocks #2, 4 are transmitted. Although not shown in FIG. 8, SS/PBCH blocks #2, 4 may be indicated by setting the second or a third bitmap to {0,1,1,0}. However, since the combined/extended periodicity has two parts, and the transmitted SS/PBCH blocks (#0, 6) of the first part are known, the UE 3 is able to derive which SS/PBCH blocks are transmitted in the second, i.e. last part of the combined/extended periodicity without additional signalling.

The third example illustrated in FIG. 8 is option (C). In this option, similarly to option (B), the pattern applicable to the first part of the periodicity is indicated using a shortened bitmap having one bit for each SS/PBCH block transmission that is enabled by the base pattern. However, in this case, the bits of the second bitmap indicate whether the respective SS/PBCH block is muted in that periodicity (i.e. not transmitted) even though enabled by the base pattern. Thus, each bit in the bitmap of option (C) is set to ‘1’ when the corresponding SS/PBCH block transmission configured by the base pattern is muted (not transmitted) in the relevant periodicity, and set to ‘0’ when the corresponding SS/PBCH block transmission configured by the base pattern is not muted (i.e. /transmitted) in the relevant periodicity. In this example, the second bitmap is set to {0,1,1,0}, for the first periodicity. Since the combined/extended periodicity has two parts, and the muted SS/PBCH blocks (#0, 6) of the first part are known from the second bitmap, the UE 3 is able to derive which SS/PBCH blocks are transmitted in the second, i.e. last part of the combined/extended periodicity without additional signalling. Alternatively, the muted SS/PBCH blocks may be signalled for the second using an associated third bitmap (and further bitmaps for each subsequent periodicity).

The benefits of options (B) and (C) is that they require smaller signalling overhead since the bitmaps have fewer bits.

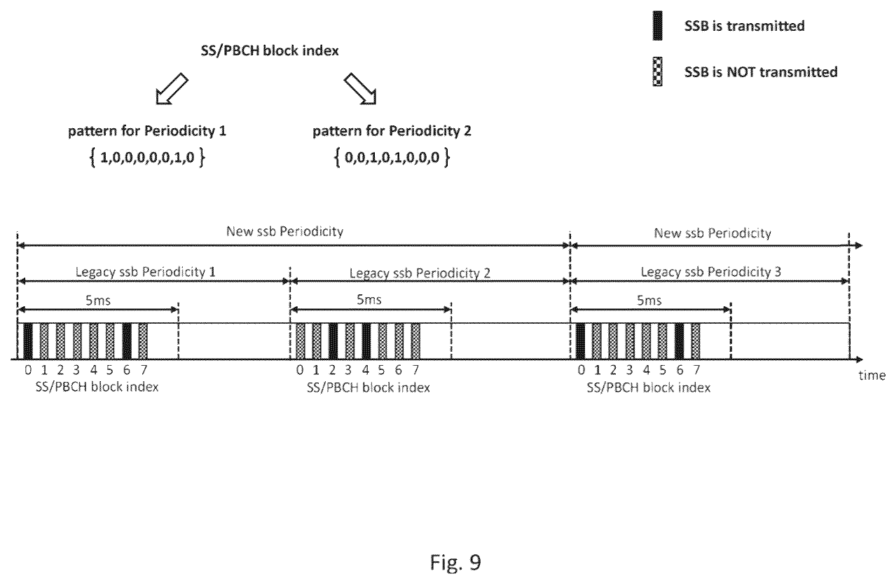

FIG. 9 illustrates another approach to determining the applicable SSB pattern in each part of the extended periodicity. In this case, the number of parts (the number of different periodicities forming the combined/extended periodicity) may be fixed (e.g. defined in the standards) or determined implicitly based on cell specific parameters. For example, an energy saving related extended periodicity may be defined with two parts (two legacy SSB periodicities), in which case is it not necessary to indicate the number of parts via system information or RRC signalling. The actual configuration of the patterns may be realised using any of the techniques discussed above with reference to FIGS. 7 and 8. However, in this example, the SSB pattern for each parts of the periodicity is determined based on a predetermined rule, for example, based on the indexes of the SS/PBCH blocks.

For example, if the index of a given SS/PBCH block is an odd number, then the SS/PBCH blocks is transmitted in one of the SSB periodicities (e.g. the first part), and if the index is an even number, the corresponding SS/PBCH block is transmitted in the other one of the SSB periodicities (e.g. the second part). It will be appreciated that any other suitable index or rule may be used. This approach can further reduce the signalling overhead since the index of the SS/PBCH blocks does not represent additional information.

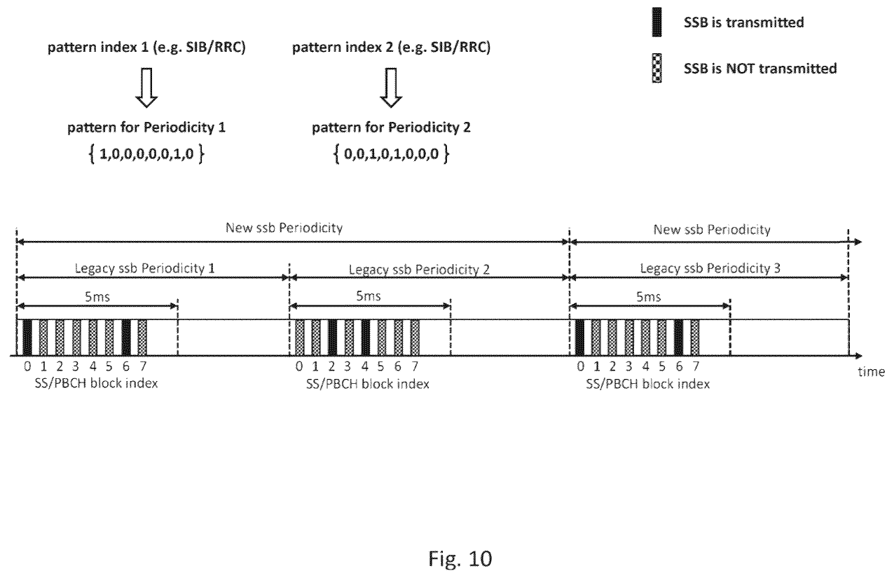

FIG. 10 illustrates another approach for signalling the applicable SSB pattern for each part of the extended periodicity. In this case, each possible pattern has an associated index (e.g. an energy saving pattern index and/or the like), and the base station 5 signals (via system information or RRC signalling) which index is applicable in which parts of the extended periodicity. In this case, the length of the extended periodicity may be indicated implicitly, based on the number of pattern indexes. It will be appreciated that if the same pattern is used in more than one part of the extended periodicity, the corresponding index may need to be signalled for each part (unless it can be determined implicitly). Effectively, each pattern index represents a specific bitmap setting for the ssb-PositionsInBurst information element (and/or one of the other information elements/bitmaps described above).

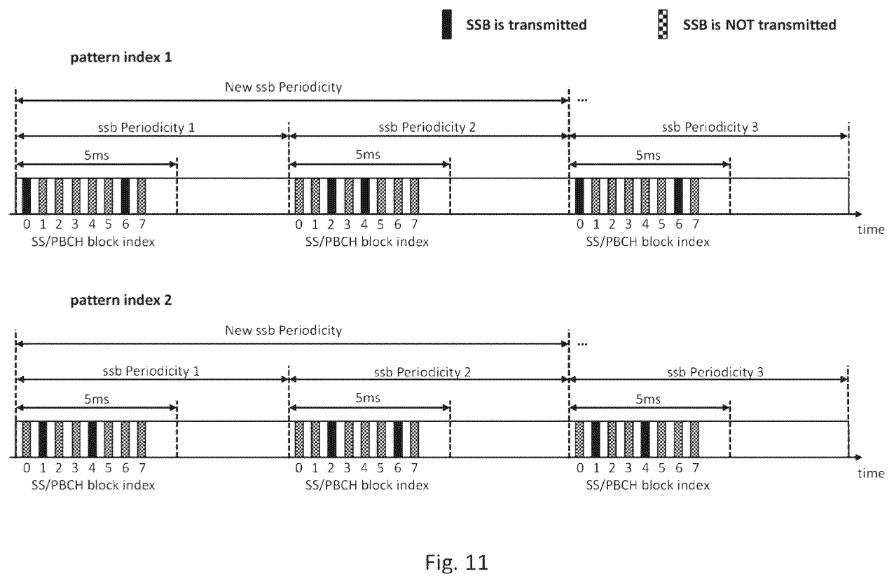

FIG. 11 illustrates yet another approach for signalling the applicable SSB pattern for the extended periodicity. In this case, a respective index (e.g. an energy saving pattern index and/or the like) is associated with each possible configuration of the extended periodicity. In other words, a single index may specify the applicable patterns for each part of the extended periodicity. It will be appreciated that by using appropriate indexes it may be possible to configure mutually exclusive SSB patterns (e.g. for different beams or different groups of UEs).

### Solution 2—On-Demand Transmission

In NR, the SSB and the minimum system information (MIB, SIB1) are defined as always-on signals, the transmission of which consumes a relatively high amount of energy. Whilst appropriate SSB patterns may be used to achieve some energy savings, this solution proposes to turn off SSB transmission (at least when energy saving operation is enabled) and provide SSB and associated signalling such as MIB/SIB1 on demand.

In more detail, SSB transmission may be turned off in a cell during certain periods of time, for example, during the night or other periods of low usage. Alternatively, the SSB transmission may employ a pattern in which SS/PBCH blocks are transmitted with relatively large gaps between them, to benefit from some energy savings.

When a UE 3 needs to receive the SSB in the cell, e.g. to receive minimum system information carried in the MIB and SIB1, the UE 3 transmits an appropriate request to the base station 5 operating the cell (or another base station serving the UE 3).

Upon receiving the request from the UE 3, the network starts transmitting the SSB (or increases the rate at which the SS/PBCH blocks are transmitted by changing to a different pattern). Once the SSB transmission corresponding to this request is finished, the network returns to the energy saving operation and does not transmit SSB until it receives another request.

It will be appreciated that the UE 3 may request SSB transmission via the random access channel (RACH), e.g. using msg1, msg3, or msgA of a random access procedure, via dedicated RRC signalling, or by using specific resources/signalling dedicated to SSB requests.

Upon transmitting the SSB request, the UE 3 starts detection of the SSB and the information included in it (using its transceiver circuit 31 and communications control module 43).

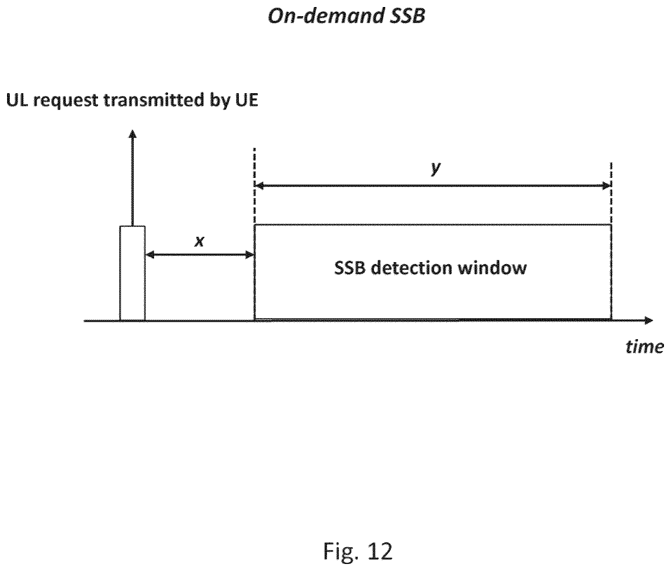

The UE 3 might be configured with a window for SSB detection as shown in FIG. 12. In this case, the window may start after a certain time (denoted ‘X’) has passed following the UE sending the request, and the window may have an associated duration (denoted ‘Y’).

The parameters (e.g. X, Y) for the SSB detection window may be configured by the network or default parameters may be used (e.g. defined in the relevant standards). Alternatively, the window may be defined in a similar way to the system information scheduling window, in which case the network informs the UE 3 about the relevant SSB scheduling information.

The window start point (X) and the window duration (Y) may be given in units of ms/slot/symbol, etc. The network may be restricted to transmit the SSBs within the window only, although transmission might be in repetition to ensure appropriate service quality.

The UE 3 may be configured to stop SSB detection when it detects (at least one) SS/PBCH block. Alternatively, the UE 3 may be configured to detect multiple SSBs (e.g. during the entire window) which may help with RRM measurement, beam training etc.

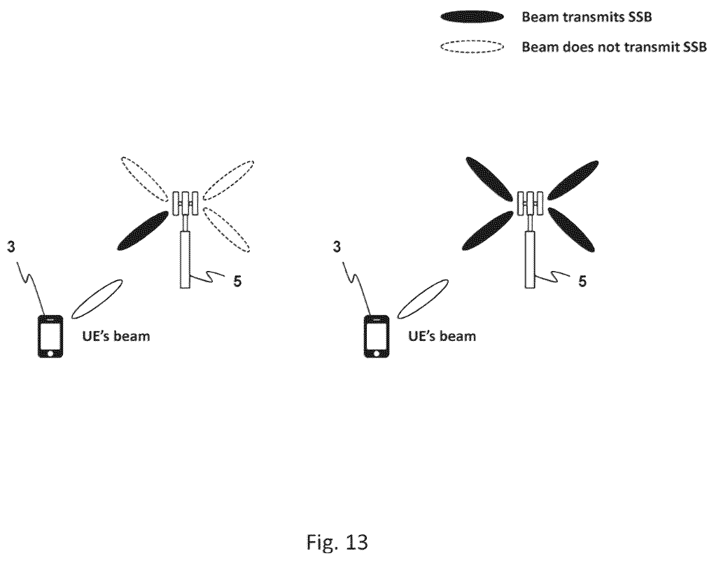

FIG. 13 illustrates two options that may be used in a case when beamforming is employed in the cell. In this case, the network may transmit the SSBs using multiple beams (thus cover the whole cell or large part of the cell), as shown in the right side of FIG. 13. In order to do so, the network may employ an SSB pattern that allows beam sweeping. A benefit of this approach is that multiple UEs 3 may receive the SSB (not only the UE 3 that has requested it). Moreover, if the requesting UE 3 moves after sending the request, it can still receive the SSB via another beam.

In the option shown in the left side to FIG. 13, the network transmits the SSB using only the beam corresponding to the beam transmitting the request. In other words, the SSB is transmitted only in the direction of the UE 3 that has requested it. In order to do so, the network may employ an appropriate SSB pattern that does not employ beam sweeping. Beneficially, this option improves energy saving since fewer beams (fewer SSB blocks) need to be transmitted (assuming that each SSB is carried via a different beam).

Regardless of which option is used by the network, the UE 3 may be configured to detect only the SSB transmitted using the beam in the direction of the UE 3. In this case, the UE 3 may also benefit from some energy saving. The cells with on-demand SSB feature may be configured as a secondary cell (SCell) for the UE 3.

### Solution 3—Dynamic SSB Transmission

As explained above, relatively dense transmission of SSB and associated minimum system information consumes more energy. On the other hand, a relatively long periodicity will result in latency.

In order to address these issues, in this solution the network controls the SSB transmission dynamically. For example, SSB transmission may be controlled based on cell load (or changes in cell load) and/or request from the UEs 3 (similarly to Solution 2). The network may control whether the SSB is transmitted or not, and/or control the SSB transmission periodicity dynamically. For example, the network may choose a longer SSB transmission periodicity, or choose not to transmit the SSB/minimum system information when the load of the cell/base station is relatively low or when no UE has requested a denser SSB transmission.

The UE 3 may be allowed to request a different (relatively denser) SSB transmission, if necessary. The network (base station 5) may take the UE's request into consideration and vary the SSB transmission periodicity or the pattern. If the periodicity is varied, the network notifies the UE(s) 3 so that they can adjust their configuration accordingly.

The UE 3 may send the network information identifying a preferred SSB transmission periodicity or pattern within the request. If the network decides to change the periodicity, it may notify at least the requesting UE(s) 3, for example, via UE dedicated signalling and/or resources. The network may notify the UE(s) of the new SSB periodicity or indicate that the preferred SSB periodicity has been accepted.

It will be appreciated that the network (base station 5) may notify all the UEs 3 in its cell, for example, by changing the system information that identifies the applicable SSB periodicity. In this case, a system information change notification will be sent first (via broadcast), followed by the new system information.

The transmission of the denser SSB might last for a predetermined period (e.g. period Y in FIG. 12), after which the network falls back to the previous longer SSB periodicity (or another periodicity), to save energy.

When the network controls the SSB transmission or SSB periodicity/pattern based on cell load, it may use one or more associated threshold.

When the load is higher than a certain threshold, the network transmits the SSB transmission (or switches from a longer periodicity to a shorter SSB periodicity/denser SSB pattern).

The definition of load may use one or more criterion, including but not limited to:
1) Only connected UEs: the network knows and takes into account the number of connected UEs in the cell;
2) UEs in any RRC state (idle/inactive/connected): the network does not know the number of idle/inactive UEs in the cell. However, the network may count the UEs by:
   Sending an appropriate request/indication to the (idle/inactive) UEs for counting purposes, e.g. via system information change, paging, etc. The UEs in the RRC idle/inactive states will respond to the request (if appropriate).
   Receiving notifications from the UEs upon camping on a cell and/or upon leaving the cell.
   The UEs' uplink transmissions may use preconfigured resources, RACH, small data etc., which may be used to count or estimate the number of UEs in the cell.

The network makes a decision based on the information collected, and informs the UEs 3 if the SSB is to be transmitted and/or the SSB periodicity or pattern is changed. This allows the UEs to detect the SSB and apply the new SSB periodicity.

### Solution 4—Access Control of Energy Saving Cells

It will be appreciated that the Solutions 1 and 2 may have negative impacts on legacy UEs (i.e. UEs that do not support the new patterns/bitmaps or do not support network energy saving functionality). Legacy UEs may not be able to work in ES (energy saving) cells.

In this solution, legacy UEs 3 are not allowed to access the cells (at least while the incompatible patterns and/or network energy saving functionality are used).

If the non-backwards compatible energy saving techniques or strategies are deployed by a cell, the network can bar legacy UEs whilst still allowing energy saving UEs to access the cell. For example, the network may indicate ‘cell barred’ in the MIB which will be interpreted by legacy UEs as the cell is barred. However, those UEs 3 that support the energy saving techniques employed by the cell (which may be indicated via the MIB/SIB1) may be configured to ignore the legacy ‘cell barred’ in the MIB. The network may indicate to compatible UEs whether the cell is barred or not using any other suitable information element (e.g. in SIB1 or in a network energy saving specific SIB, or any other SIB).

### Modifications and Alternatives

Detailed example embodiments have been described above, which relate to a system which uses a first pattern for a Synchronization Signal Block (SSB) having a first periodicity and a second pattern for the SSB having a second periodicity. The SSBs in the first and second periodicities are repeated sequentially with a third periodicity which is based on a combination of the first and second periodicities. A base station transmits pattern information to a user equipment (UE) that identifies at least one specific block of resources in the first periodicity and at least one different block of resources in the second periodicity in which the SSB is present. The SSB may be transmitted on demand (upon request by the UE or based on network load). The SSB and the patterns may be employed for energy saving at the base station. UEs that do not support this feature may be barred from accessing the cell of the base station.

As those skilled in the art will appreciate, a number of modifications and alternatives can be made to the above example embodiments whilst still benefiting from the disclosures embodied therein. By way of illustration only a number of these alternatives and modifications will now be described.

It will be appreciated that the network (base station) may apply various methods to save energy, for example:
saving spectrum: not transmitting over full bandwidth (the base station uses only a part of its available spectrum by managing bandwidth parts);
saving covered space: not transmitting power in some areas of the cell coverage (e.g. some beams);
saving power: transmitting at lower power (which effectively reduces cell coverage and/or throughput); and
saving time: not transmitting during certain periods of time (in this case the network can configure long periodicity for signalling channels, e.g. up to every 160 ms for SSS/PSS, MIB, and PRACH).

It will be appreciated that the above example embodiments may be applied to both 5G New Radio and LTE systems (E-UTRAN). The above example embodiments may also be applied to future systems (beyond 5G, 6G, etc.).

The next-generation mobile networks support diversified service requirements, which have been classified into three categories by the International Telecommunication Union (ITU); Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency). It will be appreciated that the SSB patterns/periodicities described in this document may be applicable to at least one of the above categories of UEs and/or at least one type of services (e.g. for energy saving). Different SSB patterns/periodicities (if any) may be applicable to different categories of UEs and/or different services.

In the above description, the UE, the access network node (base station), and the core network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:
gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.
gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.
gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.
gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signalling messages) between the control-plane and user-plane parts of the base station.

The above example embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment: communication and related equipment: electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: NPL 6, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access (e.g. to |
| | buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VOLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and exemplary embodiments described in the present document. Needless to say, these technical ideas and example embodiments are not limited to the above-described UE and various modifications can be made thereto.

The resources of the plurality of blocks of resources may include resources for at least one of synchronization and broadcast.

The pattern information may include at least one bitmap indicating, per block of resources in one of the two or more patterns, whether an associated synchronization signal and broadcast channel is present.

The pattern information may include: a first bitmap indicating, for the two or more patterns, a first set of at least one block of resources in which the associated synchronization signal and broadcast channel is present, and at least one second bitmap indicating, for one of the two or more patterns respectively, a second set of at least one block of resources in which the synchronization signal and broadcast channel block is present, wherein the second set is a subset of the first set. In this case, the first bitmap and the at least one second bitmap may define, for the two or more patterns, mutually exclusive blocks of resources in which the associated synchronization signal and broadcast channel is present.

The pattern information may include: a first bitmap indicating, for the two or more patterns, a first set of at least one block of resources in which the associated synchronization signal and broadcast channel is present, and at least one second bitmap indicating at least one block of resources in the first set in which the associated synchronization signal and broadcast channel is not present. In this case, the first bitmap and the at least one second bitmap may define, for the two or more patterns, mutually exclusive blocks of resources in which the associated synchronization signal and broadcast channel is not present.

The pattern information may include at least one index respectively identifying at least one of the two or more patterns. For example, the at least one index may define, for the two or more patterns, mutually exclusive blocks of resources in which the associated synchronization signal and broadcast channel is present.

Each block of resources may include a plurality of symbols in a time domain and a plurality of subcarriers in a frequency domain.

The pattern information may be associated with an energy saving operation.

The monitoring may be performed by the UE during a time window related to the request, the time window having an associated start point and a duration. The start point may be defined based on a time of the transmitting the request. The duration may be determined based on a parameter provided by the network node.

The monitoring may be performed by the UE over at least one block of resources associated with the synchronization signal and broadcast channel block. The monitoring may include monitoring at least until detection of the synchronization signal and broadcast channel block.

The monitoring may include monitoring for the synchronization signal and broadcast channel block via at least one beam. In a case that the request is transmitted over a specific beam, the monitoring may be performed over the specific beam or a corresponding beam.

The transmitting may be performed via a random access channel (RACH), via radio resource control (RRC) signalling, or via specific resources. The transmitting may be performed via signalling and/or resources associated with the synchronization and broadcast signalling block.

The pattern information may be applicable to at least one specific type of UEs in a cell of the access network node, and the method further comprises barring the cell for any other type of UEs. The pattern information may be associated with an energy saving operation and the method further comprises barring UEs that do not support the energy saving operation.

The transmitting the synchronization signal and broadcast channel may include: transmitting the synchronization signal and broadcast channel using a first, relatively low density based on the network load; and subsequently transmitting the synchronization signal block and broadcast channel using a second, relatively high density based on at least one of a change in the network load and the request from the at least one UE.

The transmitting may be performed based on the network load, in which case the network load may be determined based on at least one of: a number of UEs served by the access network node; and a number of requests from the at least one UE.

The method performed by the access network node may further comprise changing at least one parameter associated with the transmitting based on at least one of the network load and the request from the at least one UE. The at least one parameter may indicate at least one of: a pattern for the at least one block of resources for the synchronization signal and broadcast channel; a periodicity for the at least one block of resources for the synchronization signal and broadcast channel; and a beam used for the at least one block of resources for the synchronization signal and broadcast channel.

The request from the at least one UE may include information identifying a preferred periodicity for the synchronization and broadcast signalling, and the transmitting may include transmitting the synchronization signal and broadcast channel based on the preferred periodicity.

The transmitting of the synchronization signal and broadcast channel may be performed during a time window related to the request, the time window having an associated start point and a duration.

Various other modifications will be apparent to those skilled in the art and will not be described in further detail here.

The whole or part of the exemplary embodiments disclosed above can be described as, but not limited to, the following supplementary notes.

### (Supplementary Note 1)

A method performed by a user equipment (UE), the method comprising: receiving pattern information identifying two or more patterns for a plurality of blocks of resources, each pattern having a respective periodicity, and identifying a further periodicity which is based on a combination of the respective periodicities for the two or more patterns:

wherein the two or more patterns are repeated sequentially with the further periodicity.

### (Supplementary Note 2)

The method according to Supplementary Note 1, wherein the resources include resources for at least one of synchronization and broadcast.

### (Supplementary Note 3)

The method according to Supplementary Note 1 or 2, wherein the pattern information includes at least one bitmap indicating, per block of resources in one of the two or more patterns, whether an associated synchronization signal and broadcast channel is present.

### (Supplementary Note 4)

The method according to Supplementary Note 1 or 2, wherein the pattern information includes:
a first bitmap indicating, for the two or more patterns, a first set of at least one block of resources in which the associated synchronization signal and broadcast channel is present, and
at least one second bitmap indicating, for one of the two or more patterns respectively, a second set of at least one block of resources in which the synchronization signal and broadcast channel block is present, wherein the second set is a subset of the first set.

### (Supplementary Note 5)

The method according to Supplementary Note 4, wherein the first bitmap and the at least one second bitmap defines, for the two or more patterns, mutually exclusive blocks of resources in which the associated synchronization signal and broadcast channel is present.

### (Supplementary Note 6)

The method according to Supplementary Note 1 or 2, wherein the pattern information includes:
a first bitmap indicating, for the two or more patterns, a first set of at least one block of resources in which the associated synchronization signal and broadcast channel is present, and
at least one second bitmap indicating at least one block of resources in the first set in which the associated synchronization signal and broadcast channel is not present.

### (Supplementary Note 7)

The method according to Supplementary Note 6, wherein the first bitmap and the at least one second bitmap define, for the two or more patterns, mutually exclusive blocks of resources in which the associated synchronization signal and broadcast channel is not present.

### (Supplementary Note 8)

The method according to any one of Supplementary Notes 1 to 7, wherein the pattern information includes at least one index respectively identifying at least one of the two or more patterns.

### (Supplementary Note 9)

The method according to Supplementary Note 8, wherein the at least one index defines, for the two or more patterns, mutually exclusive blocks of resources in which the associated synchronization signal and broadcast channel is present.

### (Supplementary Note 10)

The method according to any one of Supplementary Notes 1 to 9, wherein each block of resources includes a plurality of symbols in a time domain and a plurality of subcarriers in a frequency domain.

### (Supplementary Note 11)

The method according to any one of Supplementary Notes 1 to 10, wherein the pattern information is associated with an energy saving operation.

### (Supplementary Note 12)

A method performed by a user equipment (UE), the method comprising: transmitting, to a network node, a request to receive at least one of a synchronization signal and broadcast channel block and minimum system information for accessing a cell; and
monitoring for the at least one of the synchronization signal and broadcast channel block and minimum system information based on the request.

### (Supplementary Note 13)

The method according to Supplementary Note 12, wherein the monitoring is performed during a time window related to the request, the time window having an associated start point and a duration.

### (Supplementary Note 14)

The method according to Supplementary Note 13, wherein the start point is defined based on a time of the transmitting the request.

### (Supplementary Note 15)

The method according to any one of Supplementary Notes 12 to 14, wherein the monitoring is performed over at least one block of resources associated with the synchronization signal and broadcast channel block.

### (Supplementary Note 16)

The method according to any one of Supplementary Notes 9 to 15, wherein the monitoring is performed over a specific beam that the request is transmitted.

### (Supplementary Note 17)

The method according to any one of Supplementary Notes 12 to 16, wherein the monitoring includes monitoring at least until detection of the synchronization signal and broadcast channel block.

### (Supplementary Note 18)

The method according to any one of Supplementary Notes 12 to 17, wherein the monitoring includes monitoring for the synchronization signal and broadcast channel block via at least one beam.

### (Supplementary Note 19)

The method according to any one of Supplementary Notes 12 to 18, wherein in a case that the request is transmitted over a specific beam, the monitoring is performed over the specific beam.

### (Supplementary Note 20)

The method according to any one of Supplementary Notes 12 to 19, wherein the transmitting is performed via a random access channel (RACH), via radio resource control (RRC) signalling, or via specific resources.

### (Supplementary Note 21)

The method according to any one of Supplementary Notes 12 to 20, wherein the transmitting is performed via signalling and/or resources associated with the synchronization and broadcast signalling block.

### (Supplementary Note 22)

A method performed by an access network node, the method comprising:
transmitting, to at least one user equipment (UE), pattern information identifying two or more patterns for a plurality of blocks of resources, each pattern having a respective periodicity, and identifying a further periodicity which is based on a combination of the respective periodicities for the two or more patterns:

wherein the two or more patterns are repeated sequentially with the further periodicity.

### (Supplementary Note 23)

The method according to Supplementary Note 22, wherein the pattern information is applicable to at least one specific type of UEs in a cell of the access network node, and the method further comprises barring the cell for any other type of UEs.

### (Supplementary Note 24)

The method according to Supplementary Note 22, wherein the pattern information is associated with an energy saving operation and the method further comprises barring UEs that do not support the energy saving operation.

### (Supplementary Note 25)

A method performed by an access network node, the method comprising:
transmitting a synchronization signal and broadcast channel over at least one block of resources based on at least one of a network load and a request from at least one user equipment (UE).

### (Supplementary Note 26)

The method according to Supplementary Note 25, wherein the transmitting the synchronization signal and broadcast channel includes:
transmitting the synchronization signal and broadcast channel using a first, relatively low density based on the network load; and
transmitting the synchronization signal block and broadcast channel using a second, relatively high density based on at least one of a change in the network load and the request from the at least one UE.

### (Supplementary Note 27)

The method according to Supplementary Note 25 or 26, wherein
the transmitting is performed based on the network load, and
the network load is determined based on at least one of:
   a number of UEs served by the access network node; and
   a number of requests from the at least one UE.

### (Supplementary Note 28)

The method according to any one of Supplementary Notes 25 to 27, further comprising changing at least one parameter associated with the transmitting based on at least one of the network load and the request from the at least one UE.

### (Supplementary Note 29)

The method according to Supplementary Note 28, wherein the at least one parameter indicates at least one of:
a pattern for the at least one block of resources for the synchronization signal and broadcast channel;
a periodicity for the at least one block of resources for the synchronization signal and broadcast channel; and
a beam used for the at least one block of resources for the synchronization signal and broadcast channel.

### (Supplementary Note 30)

The method according to Supplementary Note 25, wherein
the transmitting is performed based on the request,
the request from the at least one UE includes information identifying a preferred periodicity for the synchronization and broadcast signalling, and
the transmitting includes transmitting the synchronization signal and broadcast channel based on the preferred periodicity.

### (Supplementary Note 31)

The method according to any one of Supplementary Notes 25 to 30, wherein
the transmitting is performed based on the request, and
the transmitting is performed during a time window related to the request, the time window having an associated start point and a duration.

### (Supplementary Note 32)

A user equipment (UE) comprising:
means for receiving pattern information identifying two or more patterns for a plurality of blocks of resources, each pattern having a respective periodicity, and identifying a further periodicity which is based on a combination of the respective periodicities for the two or more patterns;
wherein the two or more patterns are repeated sequentially with the further periodicity.

### (Supplementary Note 33)

A user equipment (UE) comprising:
means for transmitting, to a network node, a request to receive at least one of a synchronization signal and broadcast channel block and minimum system information for accessing a cell; and
means for monitoring for the at least one of the synchronization signal and broadcast channel block and minimum system information based on the request.

### (Supplementary Note 34)

An access network node comprising:
means for transmitting, to at least one user equipment (UE), pattern information identifying two or more patterns for a plurality of blocks of resources, each pattern having a respective periodicity, and identifying a further periodicity which is based on a combination of the respective periodicities for the two or more patterns;
wherein the two or more patterns are repeated sequentially with the further periodicity.

### (Supplementary Note 35)

An access network node comprising:
means for transmitting a synchronization signal and broadcast channel over at least one block of resources based on at least one of a network load and a request from at least one user equipment (UE).

This application is based upon and claims the benefit of priority from Great Britain Patent Application No. 2207957.8, filed on May 30, 2022, the disclosure of which is incorporated herein in its entirety by reference.

### REFERENCE SIGNS LIST

1 mobile (cellular or wireless) telecommunication system
3 mobile device
5 base station
6 cell
7 core network
10 control plane function (CPF)
11 user plane function (UPF)
20 data network
31 transceiver circuit
33 antenna
35 user interface
37 controller
39 memory
41 operating system
43 communications control module
45 energy saving module
51 transceiver circuit
53 antenna
55 network interface
57 controller
59 memory
61 operating system
63 communications control module
65 energy saving module
71 transceiver circuit
75 network interface
77 controller
79 memory
81 operating system
83 communications control module
85 energy saving module

What is claimed is:

1. A method performed by a user equipment (UE), the method comprising:
receiving pattern information for indicating two or more patterns for a plurality of blocks of resources for at least one of synchronization and broadcast, each of the two or more patterns having a respective periodicity, and the pattern information corresponding to a further periodicity which is based on a combination of the respective periodicities for the two or more patterns;
wherein the two or more patterns are repeated sequentially with the further periodicity, and
wherein the plurality of blocks of resources indicated by the two or more patterns correspond to a further pattern with the further periodicity.

2. The method according to claim 1, wherein
the each of the two or more patterns corresponds to mutually exclusive blocks of resources among the two or more patterns.

3. The method according to claim 1, wherein
the pattern information includes at least one bitmap indicating, per block of resources in one of the two or more patterns, whether a synchronization signal and broadcast channel is present.

4. The method according to claim 1, wherein the pattern information includes:
a first bitmap for indicating, for the two or more patterns, a first set of at least one block of resources in which a synchronization signal and broadcast channel is present, and
at least one second bitmap respective corresponding to, for one of the two or more patterns, a second set of at least one block of resources in which the synchronization signal and broadcast channel block is present, wherein the second set is a subset of the first set.

5. The method according to claim 1, wherein the pattern information includes:
a first bitmap for indicating, for the two or more patterns, a first set of at least one block of resources in which the synchronization signal and broadcast channel is present, and
at least one second bitmap corresponding to at least one block of resources in the first set in which the synchronization signal and broadcast channel is not present.

6. The method according to claim 1, wherein the pattern information includes at least one index respectively corresponding to at least one of the two or more patterns.

7. The method according to claim 1, wherein each block of resources includes a plurality of symbols in a time domain and a plurality of subcarriers in a frequency domain.

8. The method according to claim 1, wherein the pattern information corresponds to an energy saving operation.

9-19. (canceled)

20. A method performed by an access network node, the method comprising:
transmitting, to a user equipment (UE), pattern information for indicating two or more patterns for a plurality of blocks of resources for at least one of synchronization and broadcast, each of the two or more patterns having a respective periodicity, and the pattern information corresponding to a further periodicity which is based on a combination of the respective periodicities for the two or more patterns;
wherein the two or more patterns are repeated sequentially with the further periodicity, and
wherein the plurality of blocks of resources indicated by the two or more patterns correspond to a further pattern with the further periodicity.

21. The method according to claim 20, wherein
the each of the two or more patterns corresponds to mutually exclusive blocks of resources among the two or more patterns.

22. The method according to claim 20, wherein
the pattern information is applicable to at least one specific type of UEs in a cell of the access network node, and the method further comprises:
barring accessing the cell for any other type of UEs.

23. The method according to claim 20, wherein
the pattern information corresponds to an energy saving operation and the method further comprises:
barring UEs that do not support the energy saving operation.

24-30. (canceled)

31. A user equipment (UE) comprising:
at least one memory storing instructions; and
at least one processor configured to process the instructions to:
receive pattern information for indicating two or more patterns for a plurality of blocks of resources for at least one of synchronization and broadcast, each of the two or more patterns having a respective periodicity, and the pattern information corresponding to a further periodicity which is based on combination of the respective periodicities for the two or more patterns;
wherein the two or more patterns are repeated sequentially with the further periodicity, and
wherein the plurality of blocks of resources indicated by the two or more patterns correspond to a further pattern with the further periodicity.

32. (canceled)

33. An access network node comprising:
at least one memory storing instructions; and
at least one processor configured to process the instructions to:
transmit, to a user equipment (UE), pattern information for indicating two or more patterns for a plurality of blocks of resources for at least one of synchronization and broadcast, each of the two or more patterns having a respective periodicity, and the pattern information corresponding to a further periodicity which is based on a combination of the respective periodicities for the two or more patterns;
wherein the two or more patterns are repeated sequentially with the further periodicity, and
wherein the plurality of blocks of resources indicated by the two or more patterns correspond to a further pattern with the further periodicity.

34. (canceled)
